(19) United States
(12) Patent Application Publication
(10) Pub. No.: US 2025/0296500 A1
(43) Pub. Date: Sep. 25, 2025

(54) TAIL LIGHT SYSTEM

(71) Applicants: Peter Eimerich, Passau (DE); Magnus Rupp, Rosenberg (DE); Ralf Hepp, Ebersbach-Musbach (DE)

(72) Inventors: Peter Eimerich, Passau (DE); Magnus Rupp, Rosenberg (DE); Ralf Hepp, Ebersbach-Musbach (DE)

(21) Appl. No.: 19/086,439

(22) Filed: Mar. 21, 2025

(30) Foreign Application Priority Data
Mar. 21, 2024 (DE) 10 2024 108 060.4

(51) Int. Cl. B60Q 1/34; B60Q 1/46

(52) U.S. Cl. CPC B60Q 1/346; B60Q 1/46

(57) ABSTRACT

A tail light with lighting means and a first input for an electrical, pulse-like flashing signal of a first frequency, and a second input for an electrical brake signal. The tail light includes a control circuit which, on the one hand, is designed to detect the presence of the electrical, pulse-like flashing signal of the first frequency at the first input or the presence of an electrical, pulsing hazard warning signal of a second frequency lower than the first frequency at the first input, and which, on the other hand, is designed to switch the tail light to a brake light mode upon detection of the pulsing hazard warning signal of the second frequency. The lighting means may be exclusively activated by the presence of a brake signal, and switch to a flashing mode upon detecting the pulse-like flashing signal of the first frequency.

### CROSS REFERENCE TO RELATED APPLICATION

This application claims priority under 35 U.S.C. § 119 to German Patent Application No. DE 10 2024 108 060.4 filed Mar. 21, 2024, the entire disclosure of which is hereby incorporated by reference herein.

### TECHNICAL FIELD

The invention relates to a tail light system with lighting means and a first input for an electrical, pulse-like flashing signal of a first frequency, and a second input for an electrical brake signal, wherein the lighting means may be activated to indicate a change in direction of travel when a flashing signal is present, and the lighting means may be activated to indicate a braking operation when a brake signal is present.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Tail lights of the cited type may be used on a vehicle as part of the lighting system which usually also includes front lights, headlights or reversing lights. With work or emergency vehicles, the use of additional hazard warning lights may be used, with the additional hazard warning lights being mounted at highly visible points on the vehicle to advise other road users to increased caution, for example due to lower driving speeds or because the vehicle identified in this way is too wide.

The operation of vehicle lights must, of course, comply with legal requirements, for example with regard to luminosity or flashing frequency, which must be observed by the vehicle manufacturer. These legal requirements sometimes differ in different countries. In the USA, for example, it is common to use a combined brake light and direction indicator and to equip emergency or work vehicles with separate hazard warning lights, wherein a frequency of 65-85 flashes per minute is specified for the operation of the hazard warning lights, and a higher frequency of 85-120 flashes per minute for the operation of the direction indicators. The flashing signal and the hazard warning signal are each present as square-wave pulses whose switch-on and switch-off times are equally long. A flashing frequency of 60 flashes per minute, for example, therefore corresponds to a switch-on time of 0.5 s, which is subsequently also referred to as the pulse length. Emergency or work vehicles generally drive on public roads with switched-on hazard warning lights, wherein in a change of the direction of travel, for example to the right, the right hazard warning light is operated at the higher frequency of a direction indicator, and the left hazard warning light is constantly lit. The right tail light may also be operated at the higher frequency of a direction indicator, while the left tail light is not activated. During a braking process, on the other hand, the left tail light is activated as a brake light, while the right tail light continues to be operated at the higher frequency of a direction indicator. For the corresponding activation of the involved lights, a separate control unit is conventionally arranged or positioned on the vehicle, which applies corresponding signals to the given light, for example a brake signal, a flashing signal or a hazard warning signal.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates an overview of the mode of operation of a lighting system common in the USA, for example, comprising two tail lights that are each designed as a combined stop light with a direction indicator, and two hazard warning lights.

FIG. 2a illustrates a schematic representation of an embodiment of the basic structure of a lighting system for realizing the mode of operation shown in FIG. 1 according to the prior art.

FIG. 2b illustrates a schematic representation of a possible embodiment of the basic structure of a lighting system for realizing the mode of operation shown in FIG. 1 according to one aspect of the invention.

FIG. 3 illustrates a block diagram of one example of a control circuit.

FIG. 4 illustrates the arrangement of a lighting system with tail lights according to one example on an agricultural vehicle.

FIG. 5 illustrates the arrangement of tail lights according to one example of an agricultural implement towed by a vehicle.

FIG. 6 illustrates the arrangement of a tail light according to an example on another agricultural implement towed by a vehicle.

### DETAILED DESCRIPTION

As discussed in the background, a separate control unit is arranged or positioned on the vehicle, which applies corresponding signals to the given light, for example a brake signal, a flashing signal or a hazard warning signal. This separate control unit must be wired to the given lights in a corresponding manner, which may be associated with corresponding costs for the control unit and its wiring.

Thus, in one or some embodiments, a system, such as a tail light system, is disclosed that avoids this cost burden and therefore is able to design lighting systems of vehicles more economically.

In one or some embodiments, the tail light system includes a lighting means, and a first input for an electrical, pulse-like flashing signal of a first frequency (e.g., the first input is configured to input the electrical, pulse-like flashing signal of the first frequency), and a second input for an electrical brake signal (e.g., the second input is configured to input the electrical brake signal). The lighting means may be activated to indicate: a change in direction of travel when a flashing signal is present; and a braking operation when a brake signal is present. In one or some embodiments, the tail light system includes a control circuit which, on the one hand, is configured to detect the presence of the electrical, pulse-like flashing signal of the first frequency at the first input or the presence of an electrical, pulsing hazard warning signal of a second frequency lower than the first frequency at the first input, and which, on the other hand, is configured to switch the tail light system to a brake light mode responsive to detecting the pulsing hazard warning signal of the second frequency. The lighting means may be exclusively activated by the presence of a brake signal (e.g., its light is turned on and stays on as long as there is the presence of the brake signal), and to switch to a flashing mode upon the control circuit detecting the pulse-like flashing signal of the first frequency (e.g., responsive to the control circuit detecting the pulse-like flashing signal of the first frequency, the control circuit switches to flashing mode, thereby commanding the lighting means to operate as flashing). Further, responsive to the control circuit detecting the presence of the flashing signal, the control circuit may command the lighting means to activate responsive thereto (e.g., generate a flashing signal). In one or some embodiments, the tail light system is therefore provided with a control circuit which is configured to detect the presence of an electrical, pulse-like flashing signal of the first frequency at the first input and/or the presence of an electrical, pulsing hazard warning signal of a second frequency lower in comparison to the first frequency, at the first input. In this way, the hazard warning signal may be applied to the first input of the tail light system in addition to the flashing signal and looped through to the hazard warning light. In addition, the control circuit is configured to switch the tail light system to a brake light mode upon detection of the pulsed hazard warning signal of the second frequency and into a flashing mode upon detection of the pulsed flashing signal of the first frequency. In brake light mode, the lighting means may only be activated upon application of a brake signal (e.g., the control circuit, in break light mode, only commands constant activation of the lighting means responsive to receipt of the brake signal), and in flashing mode, the lighting means may only be activated upon application of the flashing signal (e.g., the control circuit, in flashing mode, only commands flashing activation of the lighting means responsive to receipt of the flashing signal). With the aid of the features of control circuit of the tail light system according to one aspect of the invention, an external control unit and its wiring to the tail lights and the hazard warning lights may be dispensed with, thereby reducing the costs for the design of the lighting system.

Thus, depending on the mode of the system (e.g., as determined or set by the control circuit), the control circuit may operate differently. For example, responsive to detecting the pulsing hazard warning signal of the second frequency, the control circuit may switch to the brake light mode. Alternatively, or in addition, responsive to detecting the flashing signal of a first frequency, the control circuit may switch to the flashing mode. In the brake light mode and responsive to detecting the brake signal, the control circuit may activate the lighting means (e.g., the control circuit is configured to, in the brake light mode, only activate the lighting means responsive to detecting the brake signal). In the flashing mode and responsive to detecting the flashing signal, the control circuit may activate the lighting means (e.g., the control circuit is configured to, in the flashing mode, only activate the lighting means responsive to detecting the flashing signal).

In one or some embodiments, the brake signal, when indicative of braking, may comprise a constant predetermined level (e.g., 5V or a logic HIGH). Conversely, the brake signal, when indicative of not braking or where the brake signal is not present, may comprise a different predetermined level (e.g., 0V or a logic LOW). When the brake signal indicates breaking and while in the brake light mode, the control circuit may activate the lighting means.

In one or some embodiments, the control circuit is configured to, in the flashing mode, activate the lighting means to emit a flashing light responsive to detecting the flashing signal, as discussed above. So that, in one or some embodiments, the frequency of the control circuit activating the lighting means may be the same frequency of the flashing signal (e.g., the first frequency).

In one or some embodiments, the lighting means may comprise light bulbs, LEDs, or any other type of electrical component that produces light. Various types of electric lights are contemplated, including, for example, incandescent lamps (which produce light by a filament heated white-hot by electric current), halogen, gas-discharge lamps (which may produce light by means of an electric arc through a gas, such as fluorescent lamps), LED lamps (which may produce light by a flow of electrons across a band gap in a semiconductor), or High-Intensity Discharge (HID). As one example, electric lamps may have a base made of ceramic, metal, glass, or plastic that secures them in the socket of a light fixture.

The requirements mentioned above may nevertheless be fulfilled. If the emergency or work vehicle moves without changing the direction of travel with the hazard warning lights switched on, a pulse-like hazard warning signal of a comparatively low frequency may be applied to the first input of the left and right tail lights. The control circuit therefore may switch the given tail light system into a brake light mode (e.g., in which the lighting means may be activated, via control from the control circuit, as usual to indicate a braking process upon the application of a brake signal to the second input). In the event of a change of direction of travel, for example to the right, the first input of the right tail light is supplied with a flashing signal of a comparatively higher frequency. The control circuit therefore may switch the right tail light to a flashing mode in which the lighting means may be activated as usual to indicate a change in the direction of travel by the application of the flashing signal (e.g., in which the lighting means may be activated with a flashing output, via control from the control circuit, to indicate the change in the direction of travel upon the application of the flashing signal). The flashing signal looped through to the right hazard warning light also may operate the right hazard warning light at the higher frequency of a direction indicator. The left tail light may remain in brake light mode because a flashing signal at a comparatively higher frequency is not applied to it at the first input, but rather at a constant input signal. This constant input signal may be looped through to the left hazard warning light, which may therefore shine constantly or continually. During a braking process, the left tail light may be activated as a brake light because it is switched to brake light mode, while the right tail light may continue to be operated at the higher frequency of a direction indicator because it is switched to flashing mode. Conversely, during a different braking process, the right tail light may be activated as a brake light because it is switched to brake light mode, while the left tail light may continue to be operated at the higher frequency of a direction indicator because it is switched to flashing mode. In either instance, the different tail lights (right tail light versus left tail light) may be operated in different modes.

As described in more detail below, the control circuit has one or more electronic components that may require power and/or a power supply. The tail light system may be provided with its own power supply for this purpose, which may be connected to a power source on the vehicle. In one or some embodiments, however, the control circuit may be provided with a power supply as a power store to which the flashing signal and the hazard warning signal is applied. Despite the pulse-like electrical input signals, the power store may ensure a constant supply voltage of 3.3 V, for example, for the electronic components of the control circuit. This measure may not only avoid additional cabling effort for the power supply, but may also reduce the power requirement of the tail light system. The power store may, for example, be formed by an arrangement of parallel-connected capacitors.

In one or some embodiments, the control circuit may be configured to detect the electrical, pulse-like flashing signal of the first frequency or the electrical, pulse-like hazard warning signal of the second frequency, which may be lower in comparison to the first frequency in one of several ways. In one way the control circuit includes a bistable flip-flop comprising a first flip-flop and a second flip-flop connected to a first output of the first flip-flop, wherein a set input of the first flip-flop is connected to the first input and a reset input of the first flip-flop is connected to a first clock generator output of a clock generator whose clock time is below the pulse length of the lower second frequency and above the pulse length of the higher, first frequency, and the second flip-flop is designed as a clock-edge-controlled flip-flop with a clock input and a second output. The clock input may be connected to the inverted first input, and the second output may assume the state at the first output of the first flip-flop at the time of a falling pulse edge. The second output may form the output of the bistable flip-flop, and the state at the second output may form the state of the bistable flip-flop, and a first state of the bistable flip-flop may correspond to the brake light mode, and a second state of the bistable flip-flop may correspond to the flashing mode. The implementation of the control circuit using flip-flops may enable stable operation under the given power supply and a rapid response of the circuit to changed input signals, which may be essential for changing from the brake light mode to the flashing mode. The clock generator at the clock input of the first flip-flop may basically be a counter that resets the first flip-flop when a clock time is reached that is below the pulse length of the lower, second frequency and above the pulse length of the higher, first frequency. If the second frequency is a maximum of 85 flashes per minute, the first flip-flop may always be reset after 0.353 seconds. Therefore, if a hazard warning signal with a frequency of 85 flashes per minute is present at the first input, the first flip-flop may be set with each rising pulse edge (e.g., the set input of the first flip-flop is set to “HIGH”) and reset again after 0.353 s by the clock generator. The first flip-flop was therefore not set (the output of the first flip-flop is therefore at “LOW”). Due to the falling pulse edge on the second flip-flop, this state of the first flip-flop may be adopted (e.g., inverted as the “HIGH” state) which may cause the tail light system to switch to brake light mode. If contrastingly a flashing signal with a frequency of 120 flashes per minute is at the first input, the first flip-flop may be set with each rising pulse edge (e.g., the set input of the first flip-flop is set to “HIGH”), but is no longer reset before the falling pulse edge at the second flip-flop assumes the state of the first flip-flop, whereby the tail light system may switch to flashing mode.

In one or some embodiments, the pulse-like flashing signal and the pulse-like hazard warning signal may each be present as square-wave pulses whose switch-on and switch-off times are equally long. A flashing frequency of 60 flashes per minute, for example, therefore may correspond to a switch-on time of 0.5 s, which may also be referred to herein as the pulse length.

In one or some embodiments, the two flip-flops may be designed as JK flip-flops. Other types of flip-flops are contemplated.

In one or some embodiments, the control circuit comprises a circuit unit which is connected to the first and the second inputs as well as to the output of the bistable flip-flop and which is configured to activate the lighting means with the flashing signal of the first input or the brake signal of the second input depending on the state of the output of the bistable flip-flop. The circuit unit may include two MOSFETs, for example.

Alternatively, the control circuit may comprise at least one processor and at least one memory. Specifically, the inputs described above with regard to the bistable flip-flop may be input to the at least one processor, the functionality described with regard to the bistable flip-flop may be stored in the at least one memory (and executed by the at least one processor), and the outputs in terms of control (as described above) may be output from the at least one processor.

A hazard warning light may also be switched on permanently. In this case, a pulse with an excessively long pulse length may be present at the first input, and a falling pulse edge may not be available during this time. Although in this case the set input of the first flip-flop is set and reset by the first clock generator output, but due to the lack of a falling pulse edge, this state at the output of the first flip-flop would not be adopted by the second flip-flop. Thus, a reset input of the second flip-flop is connected to a second clock generator output of the clock generator whose clock time exceeds that of the first clock generator output. The second clock generator output of the clock generator therefore may reset the second flip-flop with a clock time that exceeds the first clock time. A potential choice may be a clock time of 0.95 s, for example, which exceeds the pulse duration assigned to a pulse frequency of 65 per minute, and therefore that of the smallest pulse frequency to be expected. With the aid of the second clock generator, the second flip-flop may be reset after the expiration of this clock time, independent of the state of the first flip-flop. The relevant tail light of the tail light system may therefore switch to brake light mode in which the brake signal is applied to the lighting means at the second input.

In one or some embodiments, a useful measure may also be that the second flip-flop is reset immediately after starting up the control circuit. Immediately after starting up the control circuit, the second flip-flop may therefore be reset (e.g., the second output is set to “LOW”) since no evaluation of past points in time is available at the very first clock pulse at which the second flip-flop is supplied with voltage for the first time.

As previously explained, with the aid of the tail light system as disclosed, an external control unit and its wiring to the tail lights and the hazard warning lights may be dispensed with. Instead, a lighting system with at least two hazard warning lights and at least two tail lights as described may be used in such a way that the tail lights each have a first input for the flashing signal as well as the hazard warning signal, and a second input for the brake signal, and in each case one tail light is electrically connected to a hazard warning light assigned thereto for forwarding the hazard warning signal. The costs for an external control unit and its wiring to the lights may accordingly be avoided.

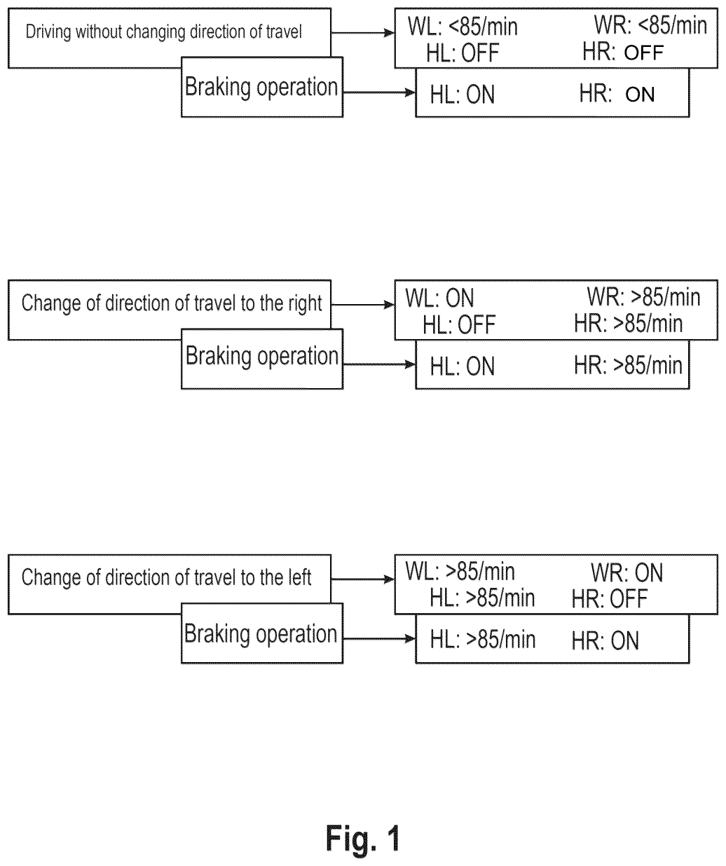

Referring to the figures, reference is first made to FIG. 1 in order to explain the mode of operation of a lighting system common in the USA, for example, which may comprise a left tail light HL, a right tail light HR (with, in one embodiment, each of the left tail light HL and the right tail light HR being designed as a combined stop light with a direction indicator), a left hazard warning light WL, and a right hazard warning light WR. In one or some embodiments, for the operation of the left hazard warning light WL and the right hazard warning light WR, a maximum limit frequency of 85 flashes per minute is provided in the depicted embodiment, which corresponds to a pulse duration at least 0.353 s, and for the operation of the direction indicators, a higher frequency of, for example, 120 flashes per minute which corresponds to a pulse duration of 0.25 s. Emergency or work vehicles generally travel on public roads with switched-on left hazard warning light WL and switched-on right hazard warning light WR, which is indicated in the upper part of FIG. 1 by “WL: <85/min, WR: <85/min”.

During a braking operation without changing the direction of travel, the left tail light HL and the right tail light HR are each activated as a brake light, which is indicated in the upper part of FIG. 1 by “HL: ON, HR: ON”. If there is no braking, the brake lights are not activated, which is indicated in the upper part of FIG. 1 by “HL: OFF, HR: OFF”. When changing the direction of travel, for example to the right, the right hazard warning light WR flashes at the higher frequency of a direction indicator, and the left hazard warning light WL shines constantly, which is indicated in the middle section of FIG. 1 by “WL: ON, WR: >85/min”. In addition, the right tail light HR is also operated at the higher frequency of a direction indicator, while the left tail light HL is not activated. This situation is indicated in the middle section of FIG. 1 by “HL: OFF, HR: >85/min”. During a simultaneous braking operation, the left tail light HL is activated as a brake light, while the right tail light HR continues to be operated at the higher frequency of a direction indicator, which is described in the middle section of FIG. 1 by “HL: ON, HR: >85/min”.

When there is a change in the direction of travel to the left, the left hazard warning light WL flashes at the higher frequency of a direction indicator, and the right hazard warning light WR shines constantly, which is indicated in the lower part of FIG. 1 with “WL: >85/min, WR: ON”. In addition, the left tail light HL is also operated at the higher frequency of a direction indicator, while the right tail light HR is not activated. This situation is indicated in the lower part of FIG. 1 with “HL: >85/min, HR: OFF”. During a simultaneous braking operation, the right tail light HR is activated as a stop light, while the left tail light HL continues to be operated at the higher frequency of a direction indicator lamp, which is described in the lower part of FIG. 1 as “HL: >85/min, HR: ON”.

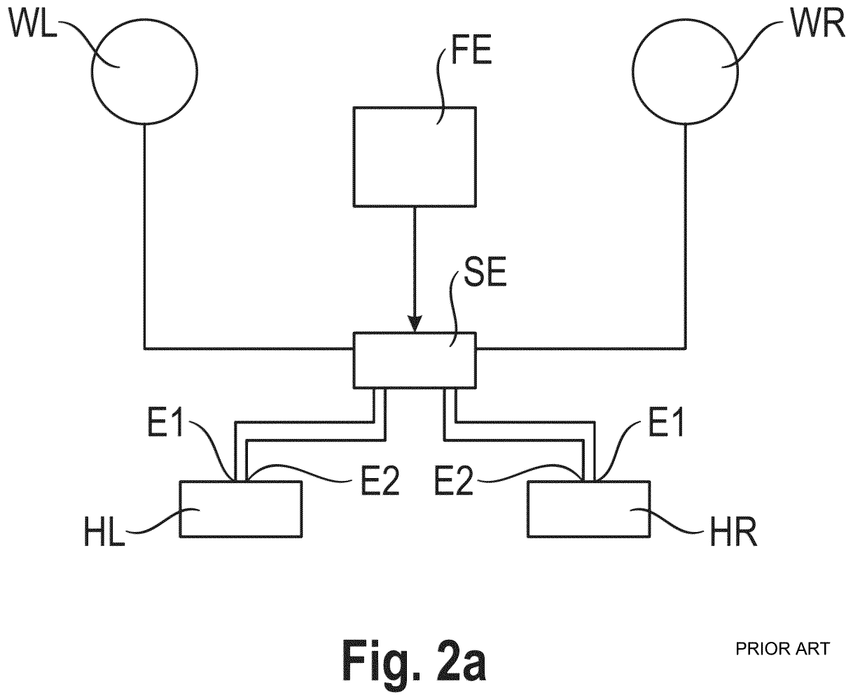

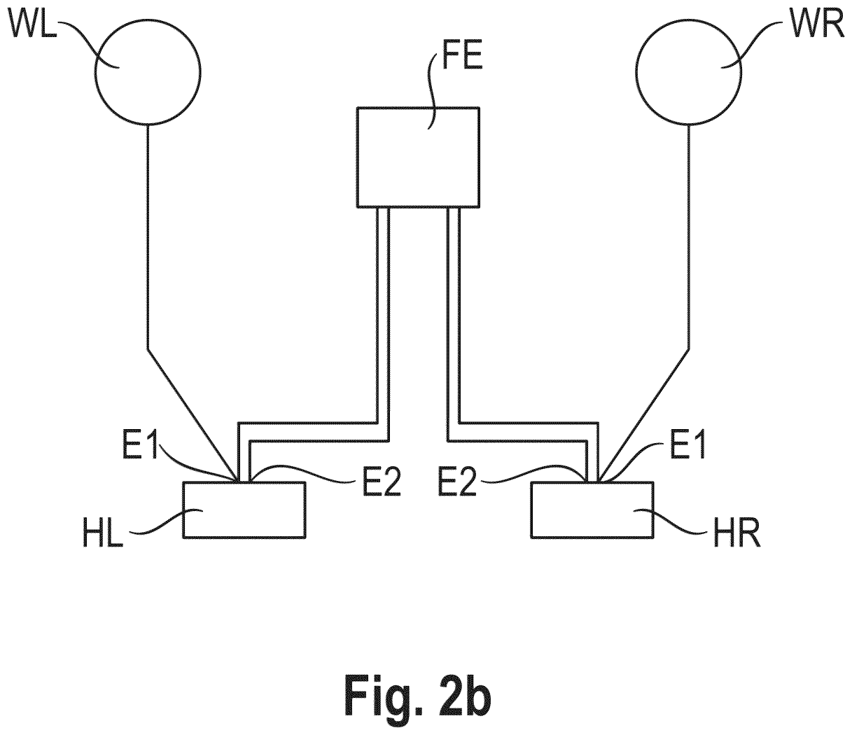

For the corresponding activation of the involved lights, a separate control unit SE may be arranged or positioned on the vehicle, which may be configured to receive commands from the vehicle electronics FE and which may apply corresponding signals to the given light, for example a brake signal, a flashing signal or a hazard warning signal, as shown in FIG. 2a. This separate control unit SE may accordingly be wired to the left tail light HL and the right tail light HR, and to the left hazard warning light WL flashes and the right hazard warning light WR, which is associated with corresponding costs for the control unit SE and its wiring, as previously explained.

In one or some embodiments, a considerably simpler configuration may be realized with the aid of one or both of the left tail light HL or the right tail light HR, as may be seen with reference to FIG. 2b, which illustrates a schematic representation of one example of a lighting system. For example, the hazard warning signal for the left hazard warning light WL may be applied to the first input E1 of the left tail light HL (in addition to the flashing signal) and looped through to the left hazard warning light WL. Similarly, the hazard warning signal for the right hazard warning light WR may be applied to the first input E1 of the right tail light HR (in addition to the flashing signal) and looped through to the right hazard warning light WR. The costs for an external control unit SE and its wiring to the lights may accordingly be avoided.

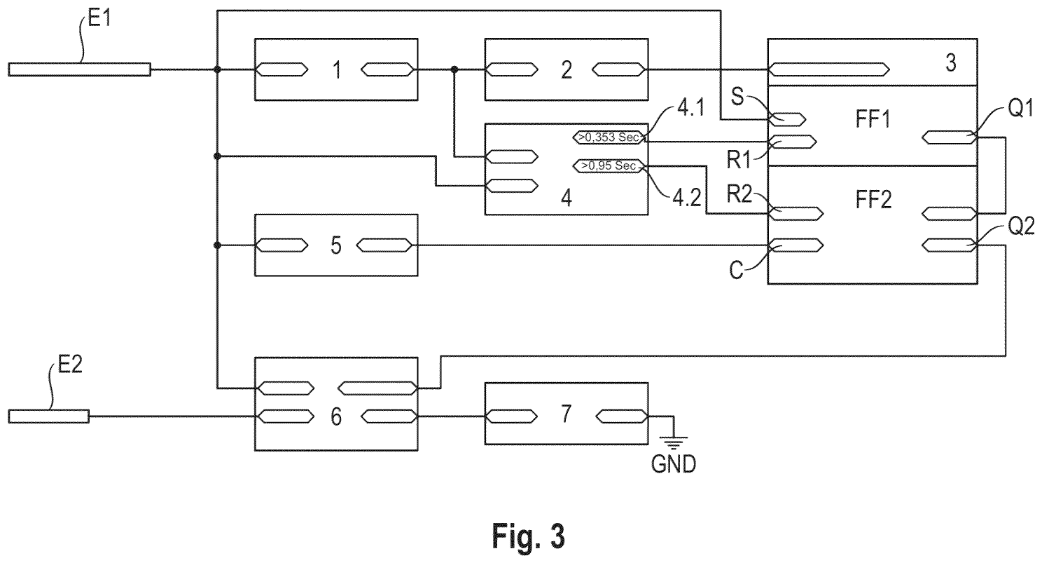

In one or some embodiments, a control circuit may be used as shown in FIG. 3, which comprises a block diagram for a control circuit according to the invention. On the left side of FIG. 3, the first input E1 and the second input E2 are shown. Usually, a hazard warning signal and alternatively a flashing signal is present at the first input E1. A brake signal is present at the second input E2 in the event of a braking operation. For the operation of the left hazard warning light WL and the right hazard warning light WR, for example, a maximum frequency of 85 flashes per minute is provided, which corresponds to a pulse duration of at least 0.353 s, and for the operation of the direction indicators, a higher frequency of, for example, 120 flashes per minute, which corresponds to a pulse duration of 0.25 s.

The input signals of the first input E1 are initially fed to an undervoltage suppressor 1 in order to filter out minor voltage fluctuations due to interference voltages. The signal filtered from interference voltages is subsequently fed to a power store 2, in which the incoming pulse-like signals are regulated to a voltage of 3.3V, for example. This voltage is provided as the power supply 3 of a first flip-flop FF1 and a second flip-flop FF2. The control circuit is accordingly provided with a power store 2 as a power supply, to which the flashing signal and the hazard warning signal are applied. Despite the pulse-like electrical input signals, the power store 2 may ensure a constant supply voltage for the electronic components of the control circuit, such as the first flip-flop FF1 and the second flip-flop FF2. The power store 2 may be formed, for example, by an arrangement of parallel-connected capacitors. Other power stores are contemplated.

The first input E1 is applied to a set input S (“SET”) of the first flip-flop FF1. The set input S of the first flip-flop FF1 is accordingly supplied with a pulse-like hazard warning signal or a pulse-like flashing signal. A reset input R1 (“RESET”) of the first flip-flop FF1 is connected to a first clock generator output 4.1 of a clock generator 4, which sends a reset signal to the reset input R of the first flip-flop FF1 after expiration of a clock time of 0.353 s. The first clock generator output 4.1 is therefore only relevant for incoming pulses with pulse lengths from 0.353 s, which is indicated in FIG. 3 with “>0.353 sec” at the first clock generator output 4.1. Therefore, if a hazard warning signal with a maximum frequency of 85 flashes per minute is present at the first input E1, the first flip-flop FF1 is set with each rising pulse edge (e.g., the set input S of the first flip-flop FF1 is set to “HIGH”), and reset again after 0.353 s by the first clock generator output 4.1. The first flip-flop FF1 was therefore not set and the first output Q1 of the first flip-flop FF1 is therefore at “LOW”. The first flip-flop FF1 may therefore also be described as “time-controlled”.

The signal present at the first input E1 is also present at a clock input C of the second flip-flop FF2, which is edge-triggered by falling pulse edges, which may be ensured by using an interposed signal generator 5. Due to a falling pulse edge at the clock input C of the second flip-flop FF2, the state at the first output Q1 of the first flip-flop FF1 is adopted and stored at the second output Q2 of the second flip-flop FF2 in the depicted embodiment. If, for example, the first output Q1 of the first flip-flop FF1 is at “LOW” because, as described above, a hazard warning signal with a pulse length of at least 0.353 s is present at the first input E1, the “LOW” state at the first output Q1 of the first flip-flop FF1 is adopted at the second output Q2 of the second flip-flop FF2 in the shown example. The first flip-flop FF1 and the second flip-flop FF2 accordingly may form a bistable flip-flop (e.g., a circuit stage that assumes one of two stable states). The second output Q2 may form the output of the bistable flip-flop, and the state at the second output Q2 may form the state of the bistable flip-flop. A first state of the bistable flip-flop may correspond to the brake light mode, and a second state of the bistable flip-flop may correspond to the flashing mode. In the depicted embodiment, for example the “LOW” state at the inverted second output Q2 of the second flip-flop FF2 is assigned to the brake light mode.

If the tail light HL, HR is switched to brake light mode, the lighting means 7 is accordingly operated as brake lights, which may be achieved with the aid of a circuit unit 6. The circuit unit 6 (alternatively termed a switching unit) is electrically connected to the first input E1 and to the second input E2 as well as to the output Q2 of the second flip-flop FF2 and may be implemented using two MOSFETs, for example. Depending on the state of the output Q2 of the second flip-flop FF2, the circuit unit 6 activates the lighting means 7 with the input signal of the first input E1 or the brake signal of the second input E2. If, for example, the output Q2 of the second flip-flop FF2 is at “LOW”, the circuit unit 6 switches to the brake light mode in which the brake signal at the second input E2 is applied to the lighting means 7.

If, contrastingly, a flashing signal with a frequency of, for example, 120 flashes per minute is at the first input E1, the first flip-flop FF1 is set with each rising pulse edge (e.g., the set input of the first flip-flop is set to “HIGH”), but is no longer reset before the falling pulse edge at the second flip-flop FF2 assumes the state of the first flip-flop FF1. This “HIGH” state at output Q2 of the second flip-flop FF2 is assigned to the flashing mode. The left tail light HL and the right tail light HR accordingly switch to the flashing mode, wherein the circuit unit 6 now applies the flashing signal at the first input E1 to the lighting means 7.

The left hazard warning light WL and the right hazard warning light WR may also be switched on permanently or constantly (for at least a predetermined amount of time), as explained with reference to FIG. 1. In this case, a pulse with a pulse length of well over 0.353 s is present at the first input E1, and a falling pulse edge is not available during this time. Although in this case the set input S of the first flip-flop FF1 is set to “HIGH” and reset by the first clock generator output 4.1 to “LOW” again after 0.353 s, due to the lack of a falling pulse edge, this state at the first output Q1 of the first flip-flop FF1 would not be adopted by the second flip-flop FF2. It is therefore provided that a reset input R2 of the second flip-flop FF2 is connected to a second clock generator output 4.2 of the clock generator 4 whose clock time exceeds that of the first clock generator output 4.1. The second clock generator output 4.2 of the clock generator 4 resets the second FF2 with a clock time that exceeds the first clock time. One possible choice would be, for example, a clock time of 0.95 s at the second clock generator output 4.2, which exceeds the pulse duration assigned to a pulse frequency of 65 per minute, and accordingly that of the smallest pulse frequency to be expected. The second clock generator output 4.2 is therefore only relevant for incoming pulses with pulse lengths from 0.95 s, which is indicated in FIG. 3 by “>0.95 sec” at the second clock generator output 4.2. The second clock generator output 4.2 may be used to the second flip-flop FF2 to “LOW” after this clock time has elapsed, regardless of the state of the first flip-flop FF1, which corresponds to a “LOW” state at output Q2 of the second flip-flop FF2. The left tail light HL and the right tail light HR accordingly switch to brake light mode, in which the brake signal at the second input E2 is applied to the lighting means 7 via the switching unit 6.

Immediately after starting up the control circuit, the second flip-flop FF2 is first reset, (e.g., the second output Q2 is set to “LOW”) since no evaluation of past points in time is available at the very first clock pulse at which the second flip-flop FF2 is supplied with voltage for the first time. This means that the brake signal at the second input E2 is applied to the lighting means 7 during the first flashing cycle.

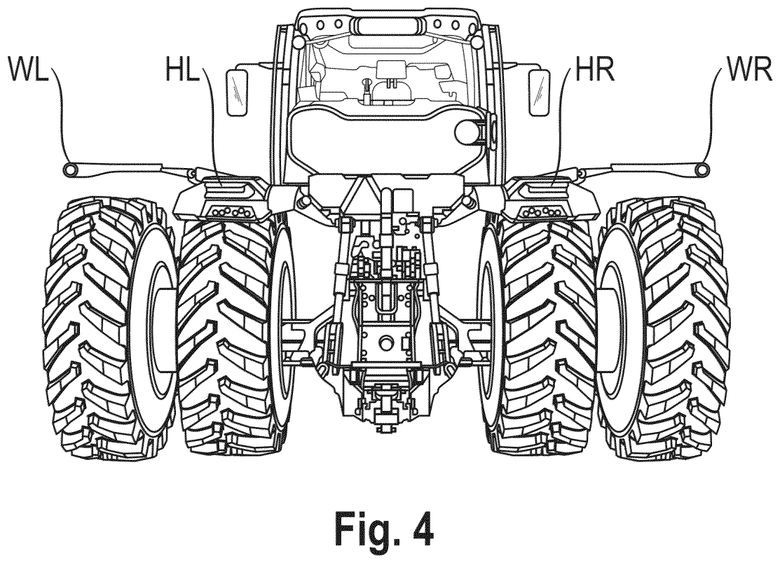

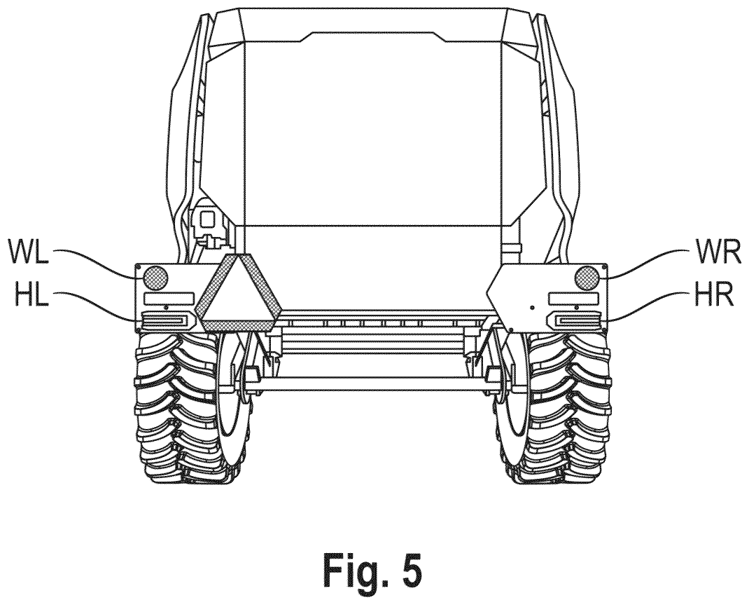

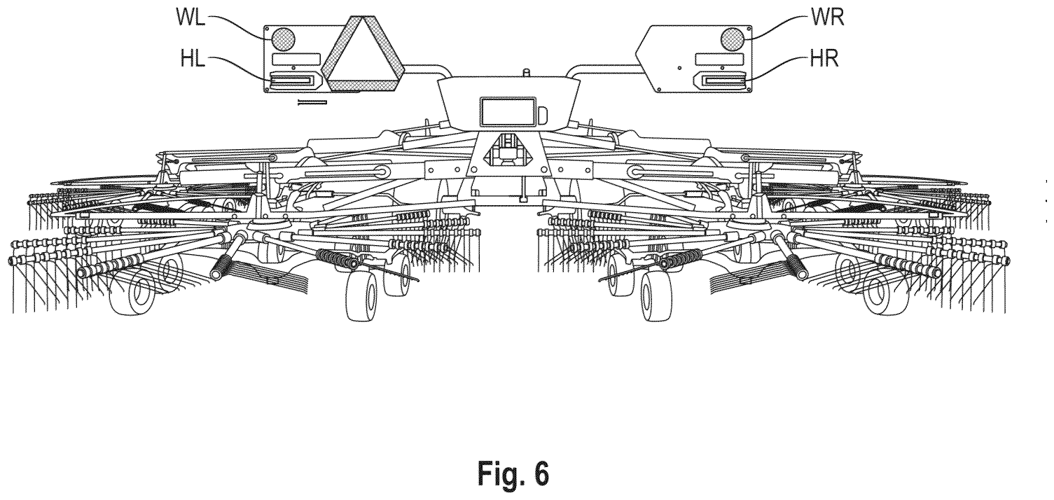

FIGS. 4-6 illustrate example embodiments of the left tail light HL and the right tail light HR and their arrangement on vehicles or implements towed by vehicles. FIG. 4, for example, shows (viewed from the rear) the arrangement of a lighting system in one aspect of the invention with the left tail light HL and the right tail light HR, and the left hazard warning light WL and the right hazard warning light WR on a tractor which is shown in FIG. 4. FIG. 5 illustrates the arrangement of the left tail light HL and the right tail light HR, and the left hazard warning light WL and the right hazard warning light WR on an agricultural implement towed by a vehicle, such as a baler. FIG. 6 illustrates the arrangement of the left tail light HL and the right tail light HR, and the left hazard warning light WL and the right hazard warning light WR on an agricultural implement towed by a vehicle.

In one or some embodiments, with the aid of the left tail light HL and the right tail light HR, an external control unit SE and its cabling with the left tail light HL and the right tail light HR, and with the left hazard warning light WL and the right hazard warning light WR, may be dispensed with. This may mean that the corresponding cost expenditure may be avoided, and lighting systems of vehicles may be designed more economically.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

1. A tail light system comprising:
a left tail light;
a right tail light;
lighting means, wherein the lighting means is configured to activate to indicate: a change in direction of travel when a flashing signal is present; and a braking operation when a brake signal is present;
a first input configured to input one or more signals;
a second input configured to input the brake signal;
a control circuit configured to:
detect, at the first input, the flashing signal of a first frequency or a pulsing hazard warning signal of a second frequency lower than the first frequency;
responsive to detecting the pulsing hazard warning signal of the second frequency, switch to a brake light mode;
responsive to detecting the flashing signal of a first frequency, switch to a flashing mode;
in the brake light mode and responsive to detecting the brake signal, activate the lighting means; and
in the flashing mode and responsive to detecting the flashing signal, activate the lighting means.

2. The tail light system of claim 1, wherein the control circuit is configured to, in the brake light mode, only activate the lighting means responsive to detecting the brake signal; and
wherein the control circuit is configured to, in the flashing mode, only activate the lighting means responsive to detecting the flashing signal.

3. The tail light system of claim 2, wherein the brake signal indicative of braking comprises a constant predetermined level;
wherein the control circuit is configured to, in the brake light mode, activate the lighting means to constantly light responsive to detecting the constant predetermined level of the brake signal; and
wherein the control circuit is configured to, in the flashing mode, activate the lighting means to emit a flashing light responsive to detecting the flashing signal.

4. The tail light system of claim 3, wherein the control circuit is configured to, in the flashing mode, activate the lighting means to emit the flashing light at the first frequency responsive to detecting the flashing signal.

5. The tail light system of claim 1, wherein the control circuit includes or receives power from a power supply as a power store to which the flashing signal and the hazard warning signal is applied.

6. The tail light system of claim 3, wherein the power store comprises parallel-connected capacitors.

7. The tail light system of claim 1, wherein the control circuit configured to detect one or both of the flashing signal of the first frequency or the hazard warning signal of the second frequency comprises a bistable flip-flop.

8. The tail light system of claim 7, wherein the bistable flip-flop comprises a first flip-flop and a second flip-flop electrically connected to a first output of the first flip-flop; and
wherein a set input of the first flip-flop is electrically connected to the first input and a reset input of the first flip-flop is electrically connected to a first clock generator output of a clock generator whose clock time is below pulse length of the lower second frequency and above the pulse length of the higher, first frequency.

9. The tail light system of claim 8, wherein the second flip-flop comprises a clock-edge-controlled flip-flop with a clock input and a second output, wherein the clock input is electrically connected to a signal based on the first input.

10. The tail light system of claim 9, wherein the clock input is electrically connected to an inverted first input;
wherein the second output assumes a state at the first output of the first flip-flop at a time of a falling pulse edge;
wherein the second output forms an output of the bistable flip-flop;
wherein the state at the second output forms the state of the bistable flip-flop; and
wherein a first state of the bistable flip-flop corresponds to a brake light mode, and a second state of the bistable flip-flop corresponds to a flashing mode.

11. The tail light system of claim 8, wherein the control circuit comprises a circuit unit that is electrically connected to the first input, the second input, and the output of the bistable flip-flop.

12. The tail light system of claim 8, wherein the control circuit is configured to activate the lighting means with the flashing signal of the first input or the brake signal of the second input depending on a state of the output of the bistable flip-flop.

13. The tail light system of claim 12, wherein a reset input of the second flip-flop is electrically connected to a second clock generator output of the clock generator whose clock time exceeds that of the first clock generator output.

14. The tail light system of claim 8, wherein the second flip-flop is reset immediately after starting up the control circuit.

15. A lighting system comprising:
at least two hazard warning lights;
at least two tail lights;
lighting means, wherein the lighting means is configured to activate to indicate: a change in direction of travel when a flashing signal is present; and a braking operation when a brake signal is present;
a first input configured to input one or more signals;
a second input configured to input the brake signal;
a control circuit configured to:
detect, at the first input, the flashing signal of a first frequency or a pulsing hazard warning signal of a second frequency lower than the first frequency;
responsive to detecting the pulsing hazard warning signal of the second frequency, switch to a brake light mode;
responsive to detecting the flashing signal of a first frequency, switch to a flashing mode;
in the brake light mode and responsive to detecting the brake signal, activate the lighting means; and
in the flashing mode and responsive to detecting the flashing signal, activate the lighting means; and
wherein in at least one of the brake light mode or the flashing mode, at least one of the at least two tail lights is electrically connected to at least one of the at least two hazard warning lights assigned thereto for forwarding the pulsing hazard warning signal.

16. The lighting system of claim 15, wherein for both of the brake light mode and the flashing mode, at least one of the at least two tail lights is electrically connected to at least one of the at least two hazard warning lights assigned thereto for forwarding the pulsing hazard warning signal.

17. An agricultural vehicle or implement towed by the agricultural vehicle that comprises at least one tail light system, the at least one tail light system comprising:
a left tail light;
a right tail light;
lighting means, wherein the lighting means is configured to activate to indicate: a change in direction of travel when a flashing signal is present; and a braking operation when a brake signal is present;
a first input configured to input one or more signals;
a second input configured to input the brake signal;
a control circuit configured to:
detect, at the first input, the flashing signal of a first frequency or a pulsing hazard warning signal of a second frequency lower than the first frequency;
responsive to detecting the pulsing hazard warning signal of the second frequency, switch to a brake light mode;
responsive to detecting the flashing signal of a first frequency, switch to a flashing mode;
in the brake light mode and responsive to detecting the brake signal, activate the lighting means; and
in the flashing mode and responsive to detecting the flashing signal, activate the lighting means.
